(19) United States
(12) Patent Application Publication
(10) Pub. No.: US 2004/0212159 A1
(43) Pub. Date: Oct. 28, 2004

(54) Method for adjusting a damping coefficient of a spring strut of a vehicle and arrangement therefor

(76) Inventor: Alexander Stiller, Garbsen (DE)

Correspondence Address: Walter Ottesen, Patent Attorney, P.O. Box 4026, Gaithersburg, MD, 20885-4026, US

(21) Appl. No.: 10/829,149

(22) Filed: Apr. 22, 2004

(30) Foreign Application Priority Data
Apr. 22, 2003 (DE) 103 18 110.5

(51) Int. Cl. B60G 17/02

(52) U.S. Cl. 280/5.515

(57) ABSTRACT

The invention is directed to a method for controlling damping for a bodywork of a vehicle. The bodywork is dampened with a first damping coefficient for a first wheel load. The change of the wheel load is detected and a second damping coefficient is determined based on the change of the wheel load so that the damping remains essentially unchanged after the change of the wheel load.

### CROSS REFERENCE TO RELATED APPLICATION

This application claims priority of German patent application no. 103 18 110.5, filed Apr. 22, 2003, the entire content of which is incorporated herein by reference.

### FIELD OF THE INVENTION

The invention relates to a method for controlling damping for a bodywork of a vehicle as well as a digital storage medium having program means for controlling damping and a control system.

### BACKGROUND OF THE INVENTION

From the state of the art, various control methods for the dampers of a vehicle are known. In the so-called ground-hook method, the control takes place in such a manner that the contact between the tires and the roadway is optimized. In contrast, the so-called skyhook method relates to the optimization of comfort.

In general, one mostly proceeds from a distribution of the bodywork load to the vehicle wheels with vehicles having adjustable dampers and this distribution is fixed. In special driving maneuvers, such as travel through a curve or up and down travel, this precondition is, however, not given. This leads to the situation that the unloaded or additionally loaded wheels are no longer optimally damped.

### SUMMARY OF THE INVENTION

In contrast to the above, it is an object to provide an improved method for adjusting a damping coefficient of a spring strut of a vehicle as well as a corresponding digital storage medium for storing a control program and a control system.

The method of the invention is for adjusting a damping coefficient of a spring strut of a vehicle. The method includes the steps of: damping the spring strut with a first damping coefficient for a first wheel load; detecting a change of the first wheel load; determining a second damping coefficient based on the change of the first wheel load so that the damping after the change remains essentially constant.

The control method of the invention makes it possible that the damping and the driving comfort associated therewith can remain essentially constant for different driving states, especially for: transverse accelerations and/or longitudinal accelerations occurring during travel; for an additional load; or for a downhill travel or an uphill travel. According to the invention, this is achieved in that the change of the wheel load is detected. Preferably, this takes place for each of the wheels. Based on the changes of the wheel loads, changes of the damping coefficients are computed for each case and in such a manner that the resulting damping at each of the wheels remains essentially unchanged.

In this way, the comfort range can be expanded during an acceleration of the vehicle. According to a preferred embodiment of the invention, the change of the wheel load is compared to a threshold value. When the change of the wheel load exceeds the threshold value, there is then an automatic changeover to another control method to improve the contact of wheel and roadway. In this way, the vehicle safety is improved in critical driving situations. After there is again a drop below the threshold value, there is again a changeover to the control for maintaining the damping constant.

In a further preferred embodiment of the invention, the change of the damping coefficient relative to the start state is limited by a maximum value with the maximum value being dependent upon the speed. Especially at higher speeds, a higher maximum value is permissible than at lower speeds.

According to a preferred embodiment of the invention, driving parameters are used for the computation of the change of the wheel load. These driving parameters are anyway available in a vehicle having a driving-dynamic control, such as ESP, on a data bus of the vehicle such as a CAN bus.

Alternatively, the wheel load can also be determined from the wheel contact force. The measurement of the wheel contact force can be determined from the variables air and spring pressure and the distance between the bodywork and the vehicle axle. A method for determining the wheel-contact force is disclosed in United States Patent Application Publication US 2003/0051554 A1 which is incorporated herein by reference.

A further possibility for determining the wheel loads is the use of an “intelligent tire” which is provided with special sensor means and evaluation devices. With the aid of such a tire, the wheel contact forces can be measured directly. The wheel loads are then determined from the wheel contact forces.

A further possibility for detecting the change of wheel loads is the measurement of the change of elevation distances between the vehicle axles and the vehicle bodywork. The change of the wheel load can be determined via the spring stiffness.

### BRIEF DESCRIPTION OF THE DRAWINGS

The invention will now be described with reference to the drawings wherein:

FIG. 1 shows a flowchart of a preferred embodiment of the method of the invention;

FIG. 2 is a block diagram of a preferred embodiment of a control system in a motor vehicle; and, FIG. 3 is a schematic showing a vehicle traveling uphill at an angle α.

### DESCRIPTION OF THE PREFERRED EMBODIMENTS OF THE INVENTION

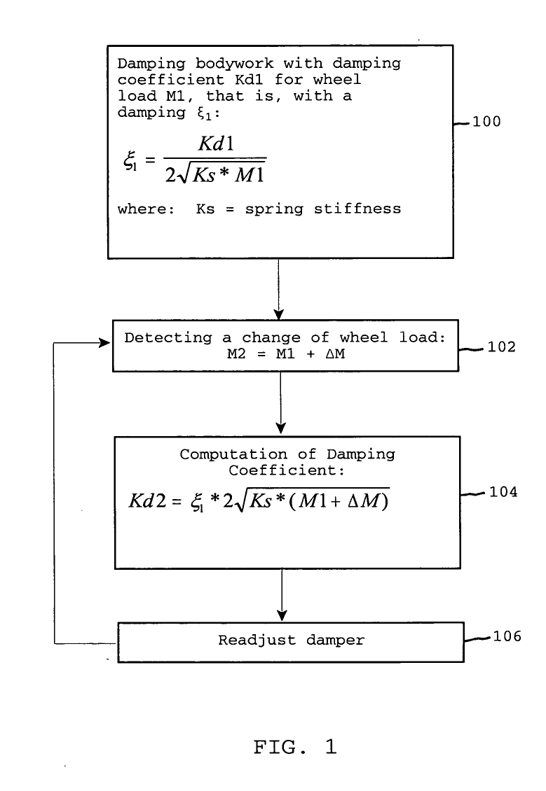

FIG. 1 shows a method for controlling damping for a bodywork of a vehicle. In step 100, the vehicle travels, for example, at a constant speed in a straight-ahead direction in a plane. In this driving state, a damping coefficient Kd1 for a wheel load M1 is adjusted on the dampers of the vehicle. From this, the damping ξ₁ results with the spring stiffness Ks with the equation:

$${ξ}_{1} = \frac{Kd1}{2 \sqrt{Ks * M1}}$$

In step 102, a change ΔM of the wheel load is detected. Such a change of wheel load can be caused by: an occurring longitudinal acceleration and/or transverse acceleration and/or by a downhill of the roadway or an uphill of the roadway. Furthermore, a change of the wheel loads can also result from an added loading. The detection of the change of the wheel loads can take place via a special sensor means or by computation based on driving parameters which, for example, are available on a data bus of the vehicle.

In step 104, a new damping coefficient Kd2 is computed as follows:

Kd2=ξ₁*2\sqrt{Ks*(M1+ΔM)}

The resulting damping ξ₂ is essentially equal to the start or initial damping ξ₁ based on this selection of the damping coefficient Kd2.

In step 106, the dampers of the vehicle are correspondingly readjusted. This has the consequence that the damping remains essentially constant also for the changed driving situation, that is, after a change of the wheel loads so that the comfort is also not changed notwithstanding the change of the driving state. This expansion of the driving comfort is perceived as pleasant by the occupants of the vehicle.

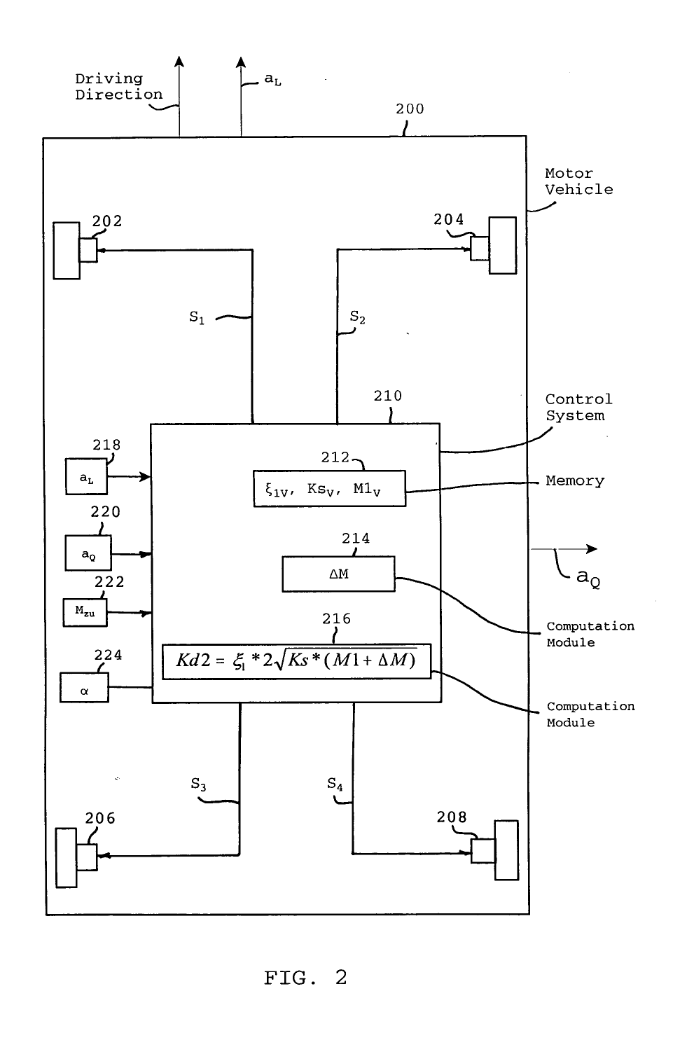

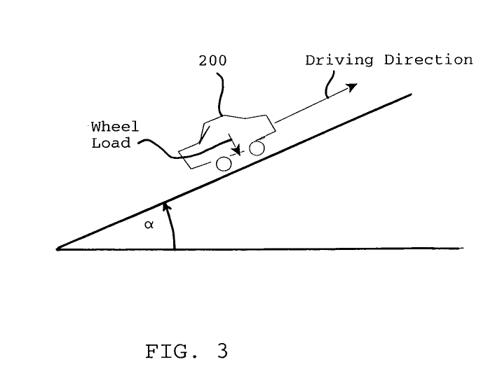

The detection of changes of the wheel loads and the computation of the damping coefficients and the readjustment of the dampers are preferably continuously executed in the steps 102, 104 and 106 so that the driving comfort remains essentially constant for different wheel loads. The steps 102, 104 and 106 are preferably executed separately for each wheel or each damper of the vehicle. This will be explained in greater detail hereinafter with respect to FIG. 2.

FIG. 2 schematically shows a motor vehicle 200 having dampers (202, 204) for the forward wheels and dampers (206, 208) for the rearward wheels. The dampers 202, 204, 206 and 208 are dampers whose spring force is adjustable via the damping coefficients. The dampers 202, 204, 206 and 208 are connected to a control system 210.

The control system 210 has a memory 212 for storing the damping coefficient ξ_{1V} of the forward damper 202 for the starting state (see step 100 of FIG. 1). Furthermore, the forward spring stiffnesses Ks_{V} and the forward wheel loads M1_{V} of the forward left wheel are stored without added loading. Furthermore, the corresponding quantities for the rear axle or the other wheels of the vehicle are also stored in the memory 212, that is, the damping coefficients for the rear dampers as well as the spring stiffnesses and wheel loads of the other wheels of the vehicle.

In the embodiment shown in FIG. 2, the control system 210 includes a computation module 214 for computing the change of the wheel loads at the wheels of the motor vehicle 200. In addition, the control system 210 has a computation module 216 for computing the damping coefficients after a change of the wheel load by AM.

The computation of the change of the wheel loads in the computation module 214 takes place, for example, based on the detection of longitudinal accelerations and/or transverse accelerations of the motor vehicle 200. Optionally, an added load M_{zu} and/or an uphill or a downhill at an angle α (FIG. 3) can also be considered with the computation of the change of the wheel loads at the wheels of the motor vehicle 200.

For example, the computation of the change of the wheel loads in the computation module 214 takes place as follows:

ΔM_{VL}=−K₁×a_{L}−K₂×a_{Q}+K₃×M_{zu}−K₄×α

ΔM_{VR}=−K₅×a_{L}+K₆×a_{Q}+K₇×M_{zu}−K₈×α

ΔM_{HL}=K₉×a_{L}−K₁₀×a_{Q}+K₁₁×M_{zu}+K₁₂×α

ΔM_{HR}=K₁₃×a_{L}+K₁₄×a_{Q}+K₁₅×M_{zu}+K₁₆×α

wherein:

ΔM_{VL}=change of the wheel load at the front left wheel;

ΔM_{VR}=change of the wheel load at the front right wheel;

ΔM_{HL}=change of the wheel load at the rear left wheel;

ΔM_{HR}=change of the wheel load at the rear right wheel;

a_{L}=longitudinal acceleration; and,

a_{Q}=transverse acceleration.

K₁ to K₁₆ are constants which are greater than 0. In general, K₁=K₅ and K₉=K₁₃. It can be assumed that K₃=K₇ and K₁₁=K₁₅ when a more or less uniform additional load is placed in the trunk of the vehicle. Furthermore, because of the configuration of the vehicle, one can assume that a distribution of the total additional load results approximately in the ratio of ¼ forward and ¾ rearward for an additional load in the trunk located at the rear. This means that K₃, K₇=⅛ and K₁₁=K₁₅=⅜.

The quantities a_{L}, a_{Q}, M and α are supplied to the control system 210 by the corresponding sensors 218, 220, 222 and 224.

A new damping coefficient Kd2 is computed in the computation module 216 for each of the dampers 202 to 208 based on the corresponding change of the wheel load. For example, the new damping coefficient Kd2 is determined for the damper 202 from the damping ξ_{1V}, the spring stiffness Ks_{V} and the wheel load M1_{V} from the memory 212 as well as the wheel load change ΔM_{VL} which is determined by the computation module 214. The same procedure is followed for all dampers.

As an alternative to the embodiment of FIG. 2, the control system 210 can also be coupled to a data bus of the motor vehicle 200. When the vehicle 200 has, for example, a driving dynamic control such as ESP, then at least the values for the longitudinal acceleration a_{L} and transverse acceleration a_{Q} are present on the data bus. The control system 210 has access to these values via the data bus in order to compute the wheel load changes ΔM in the computation module 214.

The control system 210 can further include a comparator for comparing the wheel load changes ΔM to a threshold value. When this threshold value is exceeded, the control system 210 switches to an alternate control method such as the ground-hook method in order to improve the adherence between the roadway and tires. The damping coefficients are again pregiven via the computation module 216 when there is a drop below the threshold value.

For adjusting the dampers 202 to 208 in correspondence to the damping coefficient Kd2, which is computed by the computation module 216, the control system 210 outputs signals S₁, S₂, S₃, S₄ to the dampers 202, 204, 206 and 208. The signals S₁ to S₄ are actuating signals for adjusting the computed damping coefficients individually at the dampers 202 to 208.

It is understood that the foregoing description is that of the preferred embodiments of the invention and that various changes and modifications may be made thereto without departing from the spirit and scope of the invention as defined in the appended claims.

What is claimed is:

1. A method for adjusting a damping coefficient of a spring strut of a vehicle, the method comprising the steps of:
damping said spring strut with a first damping coefficient for a first wheel load;
detecting a change of said first wheel load;
determining a second damping coefficient based on said change of said first wheel load so that the damping after said change remains essentially constant.

2. The method of claim 1, comprising the further steps of:
measuring an acceleration of said vehicle; and,
determining said change of said wheel load from said acceleration.

3. The method of claim 2, wherein the acceleration measured includes at least one of a longitudinal acceleration and a transverse acceleration.

4. The method of claim 1, wherein said change of said wheel load is detected by also considering an added load.

5. The method of claim 1, wherein a slope inclination angle is considered in the detection of said change of said wheel load.

6. The method of claim 1, wherein the detection of said change of said wheel load takes place by measuring a wheel contact force.

7. The method of claim 6, wherein the measurement of the wheel contact force takes place by measuring an air spring pressure of a damper and an elevation distance between a vehicle axle and the bodywork.

8. The method of claim 1, wherein quantities, which are required for the detection of a change of said wheel load, are made available via a bus system.

9. The method of claim 1, wherein said second damping coefficient is increased relative to said first damping coefficient during an increase of said wheel load essentially proportionally to the root from the increase of said wheel load.

10. The method of claim 1, wherein said second damping coefficient is increased relative to said first damping coefficient during an increase of said wheel load essentially proportionally to said increase of said wheel load.

11. The method of claim 1, wherein said second damping coefficient (Kd2) is computed as follows:
Kd2=ξ₁*2\sqrt{Ks*(M1+ΔM)}
wherein:
ξ₁=damping of the spring strut;
Ks=spring stiffness of the spring strut;
M1=first wheel load; and,
ΔM=change of the wheel load.

12. The method of claim 1, wherein the control of the damping is carried out separately for each damper of the vehicle.

13. The method of claim 1, comprising the further steps of:
comparing the change of said wheel load to a threshold value; and,
changing the damping to improve the roadway-tire contact when said change exceeds said threshold value.

14. The method of claim 13, comprising the further step of switching over said method to a ground-hook method when said threshold value is exceeded.

15. The method of claim 1, comprising the further step of limiting a change of said second damping coefficient relative to said first damping coefficient by a maximum value with said maximum value being dependent upon a speed of said vehicle.

16. The method of claim 15, comprising the further step of increasing said maximum value with increasing speed of said vehicle.

17. A digital storage medium comprising program means for controlling a damping for a bodywork of a vehicle wherein said program means is configured to compute a change of a damping coefficient from a change of wheel load so that the damping remains essentially constant after a change of said wheel load.

18. A control system for controlling a damping for a spring strut of a vehicle, the control system comprising:
means for computing a damping coefficient (Kd2) based on a change of a wheel load so that the damping remains essentially unchanged after the change of said wheel load; and,
means for outputting an actuating quantity for a damper to adjust said damping coefficient.

19. The control system of claim 18, wherein said means for computing the damping coefficient is configured for access to a data bus in order to access data for the computation of the damping coefficient.

20. The control system of claim 18, further comprising means for measuring an acceleration of said vehicle; and, said means for computing said damping coefficient being so configured that a change of said wheel load is determined from the acceleration data.

21. The control system of claim 18, further comprising a ground-hook control module and a comparator for comparing the change of the wheel load to a threshold value; and, means for switching over to said ground-hook control module when said threshold value is exceeded.
